(19) United States
(12) Patent Application Publication
(10) Pub. No.: US 2023/0098843 A1
(43) Pub. Date: Mar. 30, 2023

(54) LIGHT DETECTION AND RANGING SYSTEM, OPTICAL RECEIVER SYSTEM FOR A LIGHT DETECTION AND RANGING SYSTEM AND METHOD FOR OPERATING A LIGHT DETECTION AND RANGING SYSTEM

(71) Applicant: Renesas Electronics America Inc., Milpitas, CA (US)

(72) Inventors: Fulvio SCHIAPPELLI, München (DE); Giuseppe TAVANO, Dresden (DE)

(73) Assignee: Renesas Electronics America Inc., Milpitas, CA (US)

(21) Appl. No.: 17/952,435

(22) Filed: Sep. 26, 2022

(30) Foreign Application Priority Data
Sep. 30, 2021 (EP) 21200173.9

(51) Int. Cl. G01S 7/481

(52) U.S. Cl. CPC G01S 7/4815; G01S 7/4816

(57) ABSTRACT

A light detection and ranging system having a reference receiver channel and at least one comparator for comparing the output of the reference receiver channel and the output of each of the separate receiver channels to a second emitted light signal, the reference receiver channel having a reference optical sensor and a reference amplifier, wherein the at least one comparator can adjust the gain of the amplifiers of each separate receiver channels based on the result of the comparison of the output of the reference receiver channel and the output of the corresponding separate receiver channel. An optical receiver system and a method for operating a light detection and ranging system are also provided.

### CROSS-REFERENCE TO RELATED APPLICATION

The subject application claims priority under 35 U.S.C. § 119 to European Patent Application No. 21200173.9, filed on Sep. 30, 2021. The entire disclosure of European Patent Application No. 21200173.9 is incorporated by this reference.

### BACKGROUND

The present disclosure relates to a light detection and ranging system. The present disclosure further relates to an optical receiver system for a light detection and ranging system and a method for operating a light detection and ranging system.

Light detection and ranging (Lidar) systems, also called laser detection and ranging (Ladar) systems, measure the distance to a target by illuminating the target with pulsed laser light and measuring the reflected pulses with an optical sensor. Differences in laser return times and wavelength can then be used to make 3-D representations of the target. Lidar systems have become popular in automotive applications, for example in advanced safety systems. A lidar systems is for example used to scan the surroundings of a car to detect any obstacles on a collision course with the car and issue a warning to the driver and/or to initiate an emergency brake. Lidar systems are often used in autonomous cars for controlling and navigation purposes. In such automotive applications, it is essential that the Lidar systems is highly available and precise with a minimum of detection errors.

The emitting system of the light detection and ranging system comprises a light source, particularly a laser source like a laser diode, for emitting the light signal to the surroundings of the light detection and ranging system.

This emitting light signal is reflected or scattered by objects in the surroundings of the light detection and ranging system.

The optical receiver system of the light detection and ranging system usually comprises or is connected to a string of optical sensors, which are for example arranged in the front part of an automobile. For example, the optical receiver system is arranged inside the automobile and connected to the string of optical sensors via a cable. The optical receiver system comprises at least one optical receiver channel, which is connectable to a respective optical sensor.

Usually, the optical receiver system comprises a separate optical receiver channel for each optical sensor.

The optical receiver system amplifies the signal of the optical sensor before processing the optical sensor signal. The amplified optical sensor signal is usually converted from the analog domain to the digital domain by an analog-to-digital converter and afterwards being processed by a digital signal processor. Therefore, each optical receiver channel comprises a separate amplifier system for amplifying the respective optical sensor signals.

The different optical receiver channels of the optical receiver system ideally have matching amplification characteristics (gain), i.e., providing each the same result at the output in response to an identical current pulse from the optical sensor. Usually, the amplification characteristics are trimmed at low frequency, to ensure a good matching between the different optical receiver channels. However, another source of mismatch between the different optical receiver channels is represented by a mismatch in the optical sensors (photodiodes) responsivity, i.e., the ration of the generated current in response to incident light power. Thus, the output of the photo sensors in response to the same light intensity may differ from each other. This results in a different output, even for perfectly matched optical receiver channels.

Since there is no guarantee that the optical sensors used in a light detection and ranging system are selected from lots of matched devices, this mismatch between different optical sensors cannot be avoided. Furthermore, this mismatch can also not be trimmed out for each optical receiver channel using ATE (Automated Test Equipment), as the optical sensors are normally added to the light detection and ranging system by the final customer, for example car manufacturer. In addition, different customers most likely use different optical sensors, resulting in a different behaviour of the same light detection and ranging system. Finally, the light detection and ranging system, particularly the optical sensors and/or amplifiers of the optical receiver channels, are aging respectively stressed over the lifetime and may lead to a further mismatch between the output of the optical receiver channels in response to identical inputs.

On the other hand, high performance Lidar systems, as used in autonomous cars for controlling and navigation purposes, must be highly available with a minimum of detection errors and fulfil certain Automotive Safety Integrity Levels (ASILs), like e.g., an error below 9, 6 or 3 electrical degree.

It is therefore an object to provide a light detection and ranging system which is highly available with a minimum of detection errors by eliminating receiver channel mismatch.

### SUMMARY

According to the present disclosure, a light detection and ranging system comprises:

at least one first light source for emitting a light signal to the surroundings of the light detection and ranging system,

multiple receiving optical sensors for receiving a light signal from the surroundings of the light detection and ranging system, and an optical receiver system for processing the signals of the multiple receiving optical sensors, wherein the optical receiver system comprises a separate receiver channel for each receiving optical sensor, each separate receiver channel comprising an amplifier with an adjustable gain for amplifying the signal of the corresponding receiving optical sensor,

which is characterized in that

the light detection and ranging system further comprises a second light source for emitting a light signal directly to a reference receiver channel and the multiple receiving optical sensors,

further characterized in that the optical receiver system comprises the reference receiver channel and at least one comparator for comparing the output of the reference receiver channel and the output of each of the separate receiver channels, the reference receiver channel comprising a reference optical sensor and a reference amplifier,

wherein the at least one comparator can adjust the gain of the amplifiers of each separate receiver channel based on the result of the comparison of the output of the reference receiver channel and the output of the corresponding separate receiver channel.

According to the present disclosure, a mismatch between the multiple receiver channels of the optical receiver system is avoided by comparing the output of each receiver channel to the output of a reference receiver channel. Based on this comparison, the gain of the amplifiers of the multiple receiver channels can be adjusted so that the output of each receiver channel corresponds to the output of the reference receiver channel. Since the reference optical sensor of the reference receiver channel and the optical sensors connected to the multiple receiver channels are illuminated by the same light signal emitted from the second light source, the multiple receiver channels provide identical output to the same light signal after the gains of the amplifiers of the receiver channels have been adjusted by the light detection and ranging system of the present disclosure.

The present disclosure provides an online detection and correction of multiple sources of mismatch between different receiver channels of the optical receiver system in the overall receiver channel response during the whole lifetime of the light detection and ranging system. It ensures proper operation of the signal acquisition and processing channels of the light detection and ranging system with matched behaviour and thus higher predictability, accuracy and resolution. It further allows flexibility for the customers in choosing optical sensors like photodiodes, as the possible mismatches are detected and compensated during light detection and ranging system operation, regardless of the specific optical sensor responsivity.

The emitted first light signal and/or the emitted second light signal can be a light pulse with a defined characteristic, particularly wavelength, duration and form. The first light signal and the second light signal can be identical or different.

Pursuant to a variant, the multiple receiver channels and the reference receiver channel further comprise a buffer, an analog-to-digital converter and/or a signal processing unit, particularly digital signal processing unit. Particularly, the multiple receiver channels and the reference receiver channel each comprise the same elements. Since the output of each receiver channel is compared to the output of the reference receiver channel even mismatches due to the additional components is trimmed out.

According to a variant, the at least one first light source and the second light source are controlled by the light detection and ranging system and do not emit light simultaneously. Thus, an interference between both light signals is avoided, which further increases the accuracy of the light detection and ranging system. Particularly, the second light source emits light during dedicated time windows different from the time windows of the normal acquisition window, in which the at least one first light source emits light signals to the surroundings of the light detection and ranging system. In a variant, the light detection and ranging system comprises a separate comparator for each separate receiver channel, for comparing the output of the reference receiver channel to the output of the corresponding receiver channel. Thus, the output of each receiver channel can be compared to the output of the reference receiver channel in parallel, which reduces the necessary time to trim out the mismatch between the multiple receiver channel, particularly compared to a serial comparison of the output of the multiple receiver channels to the output of the reference receiver channel.

According to a variant, the amplifier of each optical receiver channel and the reference receiver channel is a transimpedance amplifier. Additionally or alternatively, the receiving optical sensors of the multiple optical receiver channels and the reference receiver channel are photodiodes and/or the first light source and/or the second light source is a laser source.

Pursuant to a further variant, the light detection and ranging system further comprises sender optics and/or receiver optics for adjusting light emitting characteristics and/or light receiving characteristics of the light detection and ranging system. The optics particularly refer to the emitting of the light signal from the at least one first light source to the surroundings of the light detection and ranging system and receiving light signal from the surroundings of the light detection and ranging system. The second light signal emitted from the second light source can be emitted directly within the light detection and ranging system to the optical sensors and reference optical sensor.

In a variant, the optical receiver system is implemented in an integrated circuit. Thus, all components of the optical receiver system are contained in a single integrated circuit (IC). This reduces susceptibility to external noise. The multiple receiver channels of this integrated circuit are for example connected to the optical sensors for receiving light signals from the surroundings of the light detection and ranging system. Alternatively, the optical sensors for receiving light signals from the surroundings of the light detection and ranging system can also be integrated into the integrated circuit.

According to the present disclosure, an optical receiver system for a light detection and ranging system is further provided. The optical receiver system is characterized in that the optical receiver system comprises the reference receiver channel and at least one comparator for comparing the output of the reference receiver channel and the output of each of the separate receiver channels, the reference receiver channel comprising a reference optical sensor and a reference amplifier,

wherein the at least one comparator can adjust the gain of the amplifiers of each separate receiver channel based on the result of the comparison of the output of the reference receiver channel and the output of the corresponding separate receiver channel.

Thus, the optical receiver system provides all necessary components for comparing the output of the multiple receiver channels to the output of the reference receiver channel and adjust the gain of the amplifiers of the multiple receiver channels to trim out any mismatch between the multiple receiver channels. Other components of the light detection and ranging system, like e.g., the optical sensors, the first light source and/or second light source might be connected to the optical receiver channel at a later stage, e.g., at the customer site during assembly of a vehicle, due complete the light detection and ranging system.

According to the present disclosure, a method for operating a light detection and ranging system comprises the steps of:

emitting a first light signal to the surroundings of the light detection and ranging system, receiving a light signal from the surroundings of the light detection and ranging system using multiple receiving optical sensors, processing the signal of the receiving optical sensors by separate receiver channels of an optical receiver system of the light detection and ranging system, wherein the processing comprises at least amplifying the signal of the receiving optical sensors by the separate receiver channels,

which is characterized in that

the method further comprises the steps of:

emitting a second light signal directly to a reference receiver channel and the multiple receiving optical sensors,

comparing the output of the reference receiver channel and the output of each of the separate receiver channels,

adjusting the gain of the amplifiers of each separate receiver channel based on the result of the comparison of the output of the reference receiver channel and the output of the corresponding separate receiver channel.

According to the present disclosure, a mismatch between the multiple receiver channels of the optical receiver system is avoided by comparing the output of each receiver channel to the output of a reference receiver channel. Based on this comparison, the gain of the amplifiers of the multiple receiver channels can be adjusted so that the output of each receiver channel corresponds to the output of the reference receiver channel. Since the reference optical sensor of the reference receiver channel and the optical sensors connected to the multiple receiver channels are illuminated by the same light signal emitted from the second light source, the multiple receiver channels provide identical output to the same light signal after the gains of the amplifiers of the receiver channels have been adjusted by the method of operating light detection and ranging system. The present disclosure provides an online detection and correction of multiple sources of mismatch between different receiver channels of the optical receiver system in the overall receiver channel response during the whole lifetime of the light detection and ranging system. It ensures proper operation of the signal acquisition and processing channels of the light detection and ranging system with matched behaviour and thus higher predictability, accuracy and resolution. It further allows flexibility for the customers in choosing optical sensors like photodiodes, as the possible mismatches are detected and compensated during light detection and ranging system operation, regardless of the specific optical sensor responsivity.

The emitted first light signal and/or the emitted second light signal can be a light pulse with a defined characteristic, particularly wavelength, duration and form. The first light signal and the second light signal can be identical or different.

Pursuant to a variant, the processing of the signal of the receiving optical sensors further comprises buffering the signal, converting the signal from the analog domain to the digital domain and/or digitally processing the signal. Particularly, the multiple receiver channels and the reference receiver channel each executed the same processing steps. Since the output of each receiver channel is compared to the output of the reference receiver channel even mismatches due to the additional processing steps is trimmed out. According to a variant, the first light signal and the second light signal are not emitted simultaneously. Thus, an interference between both light signals is avoided, which further increases the accuracy of the method for operating a light detection and ranging system. Particularly, the second light source emits light during dedicated time windows different from the time windows of the normal acquisition window, in which the at least one first light source emits light signals to the surroundings of the light detection and ranging system.

Pursuant to a further variant, the signal of the reference receiver channel and each optical receiver channel can be compared in parallel by separate comparators. Since the output of each receiver channel is compared to the output of the reference receiver channel in parallel, the necessary time to trim out the mismatch between the multiple receiver channel is reduced, particularly compared to a serial comparison of the output of the multiple receiver channels to the output of the reference receiver channel.

According to a variant, the method is performed continuously during operation of the light detection and ranging system. Since the method is performed continuously even a mismatch between the multiple receiver channels due to degradation over the lifetime of the light detection and ranging system can be trimmed out by the inventive method.

Pursuant to a variant, the steps of the characterizing portion, particularly the comparison between the output of the reference receiver channel and the output of the multiple receiver channels, is performed in predetermined intervals. It is sufficient to perform the inventive method in predetermined intervals as a mismatch between the multiple receiver channels is usually not a dynamic effect but only changing slowly over time.

### BRIEF DESCRIPTION OF DRAWINGS

FIG. 1 shows a block diagram of a light detection and ranging system according to an embodiment.

FIG. 2 shows a detailed view of an optical receiver system of the light detection and ranging system of FIG. 1 according to an embodiment.

FIG. 3 shows a detailed view of an optical receiver system according to an embodiment.

### DETAILED DESCRIPTION

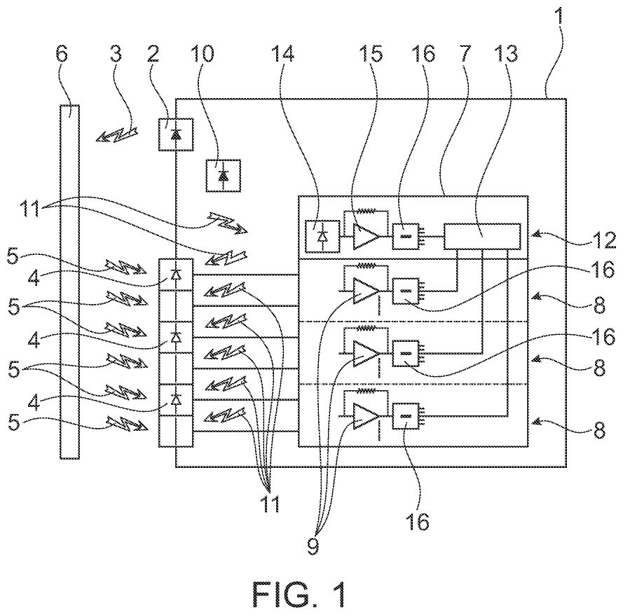

FIG. 1 shows a block diagram of an exemplary embodiment of a light detection and ranging system 1.

The light detection and ranging system 1 comprises a first light source 2 for emitting a light signal to the surroundings of the light detection and ranging system 1. The first light source 2 is for example a laser source that emits laser pulses to the surroundings of the light detection and ranging system 1.

The emitted light signal 3 hits objects 6 in the surroundings of the light detection and ranging system 1 and is reflected or scattered back to the light detection and ranging system 1. These light signals from the surroundings reflected or scattered back to the light detection and ranging system 1 are indicated in FIG. 1 by reference 5.

The light detection and ranging system 1 further comprises multiple receiving optical sensors 4 for receiving the light signals 5 from the surroundings of the light detection and ranging system 1. These receiving optical sensors 4 are for example photodiodes. The receiving optical sensors 4 are for example arranged in the front part of a vehicle.

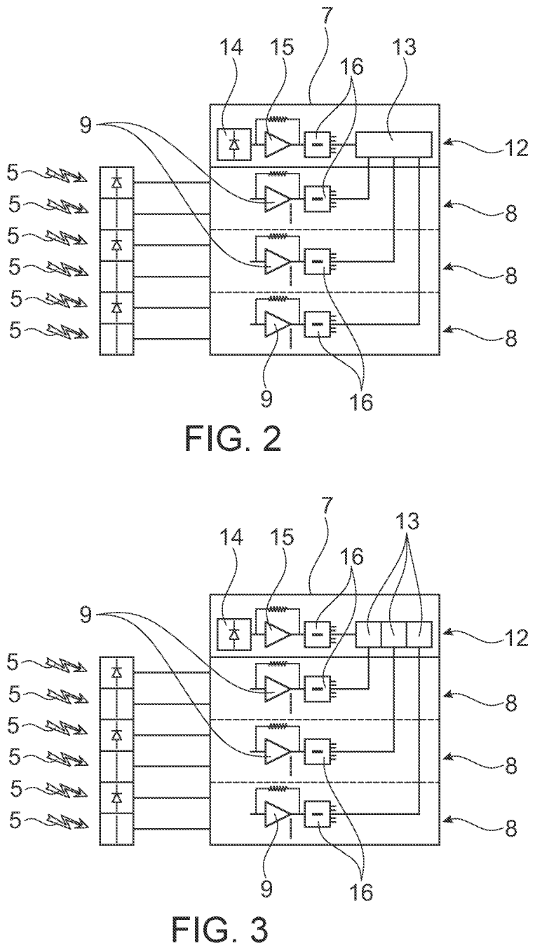

The signals of the multiple receiving optical sensors 4 are processed by an optical receiver system 7 of the light detection and ranging system 1. A detailed view of the optical receiver system 7 of the light detection and ranging system 1 of FIG. 1 is shown in FIG. 2. The optical receiver system 7 can be implemented in a single integrated circuit.

The optical receiver system 7 comprises a separate receiver channel 8 for each receiving optical sensor 4. In FIGS. 1 and 2, the separate receiver channels 8 are separated by dashed lines. Each separate receiver channel 8 comprises at least an amplifier 9 for amplifying the signal of the corresponding receiving optical sensor 4. The amplifiers 9 have an adjustable gain, to adjust the amplification of the signal of the corresponding receiving optical sensor 4. According to the embodiment shown in FIG. 1, each receiver channel further comprises a signal processing block 16, which for example comprises a buffer, an analog-to-digital converter and/or a signal processing unit.

According to the present disclosure, the light detection and ranging system 1 further comprises a second light source 10, like a laser source, for emitting a light signal 11 directly to a reference receiver channel 12 of the optical receiver system 7 and the multiple receiving optical sensors 4. The reference receiver channel 12 comprises a reference optical sensor 14 and a reference amplifier 15. Like the separate receiver channels 8, the reference receiver channel 12 also comprises a signal processing block 16 comprising a buffer, an analog-to-digital converter and/or a signal processing unit.

The optical receiver system 7 further comprises a comparator 13 for comparing the output of the reference receiver channel 12 and the output of each of the separate receiver channels 8. The comparator 13 can adjust the gain of the amplifiers 9 of each separate receiver channel 8 based on the result of the comparison of the output of the reference receiver channel 12 and the output of the corresponding separate receiver channel 8. The comparator 13 adjusts the gain of the amplifiers of the separate receiver channels 8 in such a way, that the output of each separate receiver channel 8 corresponds to the output of the reference receiver channel 12. Thus, each separate receiver channel 8 provides the same output to the same light signal 11, i.e., the light signal 11 emitted by the second light source 10. According to the embodiment shown in FIGS. 1 and 2, the optical receiver system 7 comprises one comparator 13 for comparing the output of the reference receiver channel 12 and the output of each of the separate receiver channels 8. This comparison can be performed serially or at least partially in parallel. The comparator 13 can be part of the optical receiver system 7 but could also be a separate part of the light detection and ranging system 1.

The first light source 2 and the second light source 10 are controlled by the light detection and ranging system 1 and do not emit light simultaneously. Thus, an interference between the emitted light signals 3 and 11 and processing of the light signals 5 from the surroundings and light signals 11 from the second light source 10 can be avoided.

The amplifiers 9 of the separate receiver channels 8 and the reference amplifier 15 of the reference receiver channel 12 are for example transimpedance amplifiers. The receiving optical sensors 4 of the separate receiver channels 8 and the reference optical sensor 14 of the reference receiver channel 12 are for example photodiodes. The light detection and ranging system 1 can further comprise sender optics and/or receiver optics (not shown) for adjusting light emitting characteristics and/or light receiving characteristics of the light detection and ranging system 1.

FIG. 3 shows a detailed view of another embodiment of an optical receiver system 7. The optical receiver system 7 shown in FIG. 3 differs from the optical receiver system 7 shown in FIG. 2 in that the optical receiver system 7 comprises a separate comparator 13 for each separate receiver channel 8. Thus, the outputs of all separate receiver channels 8 can be compared fully in parallel to the output of the reference receiver channel 12 by the multiple comparators 13. Again, the comparators 13 are not necessarily part of the optical receiver system 7 but could also be a separate part of the light detection and ranging system 1. With respect to all other features the optical receiver system 7 of FIG. 3 corresponds to the optical receiver system 7 of FIG. 2 and can be for example used in a light detection and ranging system 1 as shown in FIG. 1.

What is claimed is:

1. A light detection and ranging system comprising:
at least one first light source for emitting a light signal to the surroundings of the light detection and ranging system, multiple receiving optical sensors for receiving a light signal from surroundings of the light detection and ranging system;
an optical receiver system for processing the signals of the multiple receiving optical sensors, wherein the optical receiver system comprises a separate receiver channel for each of the multiple receiving optical sensors, each separate receiver channel comprising an amplifier with an adjustable gain for amplifying the signal of the corresponding receiving optical sensor; and
a second light source for emitting a light signal directly to a reference receiver channel and the multiple receiving optical sensors,
wherein the optical receiver system comprises the reference receiver channel and at least one comparator for comparing the output of the reference receiver channel and the output of each of the separate receiver channels, the reference receiver channel comprising a reference optical sensor and a reference amplifier, and
wherein the at least one comparator can adjust the gain of the amplifiers of each separate receiver channel based on the result of the comparison of the output of the reference receiver channel and the output of the corresponding separate receiver channel.

2. The light detection and ranging system according to claim 1,
wherein the multiple receiver channels and the reference receiver channel further comprise a buffer, an analog-to-digital converter and/or a signal processing unit, particularly a digital signal processing unit.

3. The light detection and ranging system according to claim 1,
wherein the at least one first light source and the second light source are controlled by the light detection and ranging system and do not emit light simultaneously.

4. The light detection and ranging system according to claim 1, comprising a separate comparator for each separate receiver channel, for comparing the output of the reference receiver channel to the output of the corresponding receiver channel.

5. The light detection and ranging system according to claim 1,
wherein the amplifier of each optical receiver channel and the reference receiver channel is a transimpedance amplifier.

6. The light detection and ranging system according to claim 1,
wherein the receiving optical sensors of the multiple optical receiver channels and the reference receiver channel are photodiodes and/or the first light source and/or the second light source is a laser source.

7. The light detection and ranging system according to claim 1, further comprising sender optics and/or receiver optics for adjusting light emitting characteristics and/or light receiving characteristics of the light detection and ranging system.

8. The light detection and ranging system according to claim 1,
wherein the optical receiver system is implemented in an integrated circuit.

9. An optical receiver system for a light detection and ranging system, the light detection and ranging system comprising:
at least one first light source for emitting a light signal to surroundings of the light detection and ranging system, multiple receiving optical sensors for receiving a light signal from surroundings of the light detection and ranging system; and
a second light source for emitting a light signal directly to a reference receiver channel and the multiple receiving optical sensors,
wherein the optical receiver system comprises:
a separate receiver channel for each of the multiple receiving optical sensors, each separate receiver channel comprising an amplifier with an adjustable gain for amplifying the signal of the corresponding receiving optical sensor;
the reference receiver channel; and
at least one comparator for comparing the output of the reference receiver channel and the output of each of the separate receiver channels,
wherein the reference receiver channel comprises a reference optical sensor and a reference amplifier, and
wherein the at least one comparator can adjust the gain of the amplifiers of each separate receiver channel based on the result of the comparison of the output of the reference receiver channel and the output of the corresponding separate receiver channel.

10. A method for operating a light detection and ranging system comprising:
emitting a first light signal to the surroundings of the light detection and ranging system;
receiving a light signal from the surroundings of the light detection and ranging system using multiple receiving optical sensors;
processing the signal of the receiving optical sensors by separate receiver channels of an optical receiver system of the light detection and ranging system, wherein the processing comprises at least amplifying the signal of the receiving optical sensors by the separate receiver channels;
emitting a second light signal directly to a reference receiver channel and the multiple receiving optical sensors;
comparing the output of the reference receiver channel and the output of each of the separate receiver channels; and
adjusting the gain of the amplifiers of each separate receiver channel based on the result of the comparison of the output of the reference receiver channel and the output of the corresponding separate receiver channel.

11. The method according to claim 10,
wherein the processing of the signal of the receiving optical sensors further comprises buffering the signal, converting the signal from an analog domain to the digital domain and/or digitally processing the signal.

12. The method according to claim 10,
wherein the first light signal and the second light signal are not emitted simultaneously.

13. The method according to claim 10,
wherein the signal of the reference receiver channel and each optical receiver channel are compared in parallel by separate comparators.

14. The method according to claim 10,
wherein the method is performed continuously during operation of the light detection and ranging system.

15. The method according to claim 10,
wherein the steps of the characterizing portion are performed in predetermined intervals.
